(19) United States
(12) Patent Application Publication
(10) Pub. No.: US 2005/0060926 A1
(43) Pub. Date: Mar. 24, 2005

(54) Mosquito attracting and killing apparatus with air cleaning function

(76) Inventors: Kyeong-Won Lee, Kyunggi-do (KR); Youn-Hwan Kim, Chungcheongnam-do (KR)

Correspondence Address: MARGER JOHNSON & MCCOLLOM, P.C., 1030 SW MORRISON STREET, PORTLAND, OR, 97205, US

(21) Appl. No.: 10/984,590

(22) Filed: Nov. 8, 2004

Related U.S. Application Data
(63) Continuation-in-part of application No. 10/484,090, filed on Jan. 16, 2004, now abandoned.

(30) Foreign Application Priority Data
Jul. 20, 2001 (KR) 2001-43847

(51) Int. Cl. A01M 1/08

(52) U.S. Cl. 43/113; 43/139

(57) ABSTRACT

Disclosed is a mosquito attracting and killing apparatus with an air cleaning function. The mosquito attracting and killing apparatus attracts mosquitoes using a UV lamp and the mosquitoes are sucked into a collecting net by operation of a fan. The contiuous operation of the fan prevents the mosquitoes from escaping out of the collecting net and kills them. In addition, the mosquito attracting and killing apparatus employs a hopper having a tapered shape to easily clean the inside of the apparatus and efficiently reflect UV light emitted from the UV lamp.

This application is a Continuation-In-Part of U.S. patent application Ser. No. 10/484,090, filed on Jan. 16, 2004, now pending, which is herein incorporated by reference in its entirety.

### BACKGROUND OF THE INVENTION

1. Field of the Invention

The present invention relates to a mosquito attracting and killing apparatus with an air cleaning capability, and more particularly, to a mosquito attracting and killing apparatus including a photo catalyst for performing deodorization and oxidation of organic compounds, and sterilization of disease-causing bacteria, by use of a photochemical reaction of the photo catalyst, as well as serving to attracting and killing mosquitoes.

2. Description of the Related Art

Mosquitoes have a behavioral habit of being attracted by the smell of host animals and heat or carbon dioxide generated from the host animals. Generally, there are several ways to control mosquitoes, for example, chemical controlling using a mosquito coil or the like; biological controlling using loaches or the like; physical controlling which attracts mosquitoes by means of a mosquito-attracting lamp, carbon dioxide or the like and then applies high voltage; and environmental controlling which improves the surrounding environment such that mosquitoes larvae cannot proliferate (for instance, removing water pools).

Up to now, in order to control mosquitoes in livestock stables or gardens, physical repelling has been widely used. However, physical repelling using high voltage causes some drawbacks as follows: a person or livestock may be subject to an electric shock; the noise pollution may be caused due to noise produced when killing mosquitoes using high voltage; a lot of electricity is consumed; and an offensive smell is given off when mosquitoes are killed. In addition, it is impossible to exterminate mosquitoes simply by killing mosquitoes, and the reduction of damage caused by mosquitoes is limited. Accordingly, there remains a need for a multipurpose mosquito controlling apparatus capable of killing mosquitoes, and simultaneously removing offensive odors and exterminating pathogens by improving the surrounding environment.

### SUMMARY OF THE INVENTION

Accordingly, the present invention is designed to solve the above drawbacks contained in the related art, and it is an object to provide a mosquito attracting and killing apparatus having an air cleaning function in combination with a deodorization function, and oxidization and sterilization functions of organic compounds, and further capable of resolving problems associated with use of high voltage exhibited in conventional methods.

To accomplish the above object and other advantages, there is provided a mosquito attracting and killing apparatus with an air cleaning function. The mosquito attracting and killing apparatus comprises:

a collecting container having an inlet provided on an upper side thereof and an outlet provided on a lower side thereof, and a vacant space therein;

a hopper having a tapered shape, such that an inner diameter of an inlet provided on the upper side thereof is larger than that of an outlet provided on the lower side thereof;

a UV lamp, emitting UV light with a wavelength of 340 to 380 nm, and installed at the inlet of the collecting container such that a lamp body can be installed detachably therefrom;

a collecting net detachably installed at the outlet of the collecting container;

a TiO2 coated layer provided on the inner surface of the hopper by coating anatase type TiO2; and

a fan provided inside of the hopper so that mosquitoes, which have been attracted by C)2 produced by the UV light, and a photochemical reaction between the UV light and TiO2 coated layer, are killed in the course of being sucked into the collecting net by operation of the fan.

Further, the collecting container may be provided at the inlet thereof with a carbon dioxide generating device for diffusing carbon dioxide.

### BRIEF DESCRIPTION OF THE DRAWINGS

FIGS. 1a and 1b are exploded perspective views illustrating the structure of a mosquito attracting and killing apparatus with an air cleaning function according to the present invention.

### DESCRIPTION OF THE PREFERRED EMBODIMENTS

Hereinafter, there is described a preferred embodiment of the present invention with reference to the accompanying drawings in detail.

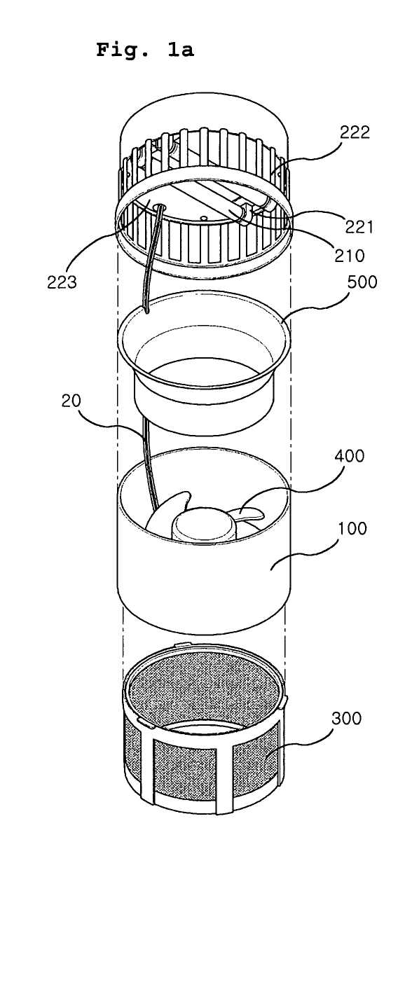

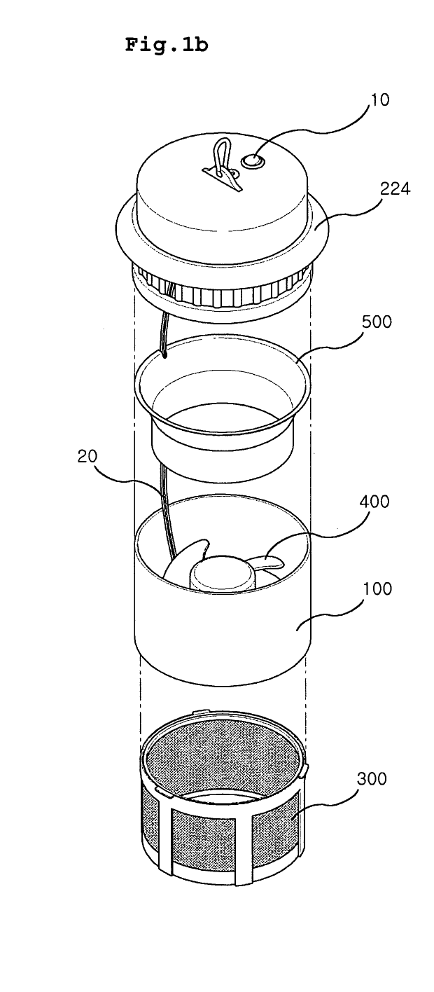

FIGS. 1a and 1b are exploded perspective views illustrating the structure of a mosquito attracting and killing apparatus with an air cleaning function according to the present invention.

Referring to FIGS. 1a and 1b, a mosquito attracting and killing apparatus with an air cleaning function according to the present invention comprises a collecting container 100, a fan 400, a UV light mosquito-attracting lamp 210, a collecting net 300, a hopper 500 and a photo catalyst-coated layer (not shown).

The collecting container 100 includes an inlet and an outlet, and is provided with a tapered portion inside thereof that becomes gradually narrower towards the outlet, in other words, an outlet inner diameter of the collecting container is smaller than an inlet inner diameter thereof.

A UV lamp emitting UV light with a wavelength which attracts mosquitoes, i.e., wavelength of 340 nm to 380 nm, is used as the UV light mosquito-attracting lamp 210. In this connection, wavelengths of 340 to 380 nm are most suitable for attracting mosquitoes, generate carbon dioxide well by reaction with a photo catalyst-coated layer that will be described below, and are safe and less harmful to humans. A lamp body, in which the UV lamp is installed, includes a lamp seat 221 for maintaining a distance between the UV light mosquito-attracting lamp 210 and the inlet of the collecting container 100 when the lamp body is engaged to the collecting container 100, a reflective plate 223 for reflecting UV light emitted from the lamp 210, and grids 222, provided between the lamp seat 221 and the inlet of the collecting container 100, for emitting the UV light outward and receiving mosquitoes. Preferably, in order to prevent rainwater from flowing into the collecting container 100 through the grids 222, a collar 224 is provided on an upper portion of the grids 222. The lamp body is detachably fitted into the inlet of the collecting container 100.

The hopper 500 is installed within the collecting container 100 and is being tapered such that an inner diameter of an inlet provided on the upper side thereof is larger than that of the outlet provided on the lower side thereof. Therefore, by separately installing the hopper 500 within the collecting container 100, when the collecting container is filled and contaminated with dead mosquitoes, it is possible to easily clean the container, efficiently reflect UV light emitted from the UV lamp 210 positioned on the upper part of the hopper 500, due to a tapered shape thereof, and thus effectively induce a photo catalytic reaction by the TiO2 coated layer. In addition, suction force of the fan 400 installed within the hopper 500 is concentrated, as described below.

The collecting net 300 is detachably fitted into the outlet of the collecting container 100.

The fan 400 is installed within the hopper 500 so that mosquitoes attracted by the UV light mosquito-attracting lamp 210 are sucked into the collecting net 300. Accordingly, mosquitoes attracted by the UV light mosquito-attracting lamp 210 are killed in the course of being sucked into the collecting net 300 by the fan 400. The fan 400 is operated by application of electric current via a cable 20, connected to a switch 10 installed on the outside of the lamp body, i.e., the switch 10 installed on the outer surface of the collecting container 100, and a motor for driving the fan 400 and the lamp 210, and passing through a space between the collecting container 100 and hopper 500. As described above, by passing the cable 20 between the collecting container 100 and hopper 500, the cable 20 is prevented from contamination due to dead mosquitoes. Further, since the cable 20 is isolated from the fan 400 by the hopper 500, there is no risk of the cable and fan becoming entangled, thus preventing malfunction thereof, when the fan operates.

When the collecting net 300 is filled with dead mosquitoes, the collecting net 300 is detached from the collecting container 100, and then is emptied.

On the inner surface of the hopper 500 is formed a layer coated with anatase type TiO2 as a photo catalyst. Naturally occurring titanium dioxide(TiO2) may be largely classified into rutile-, anatase- and brookite-type, depending on their crystal structure. The brookite-type is used almost exclusively for scientific applications, while for industrial applications, rutile- or anatase-type titanium dioxide is largely used. Anatase-type titanium dioxide has a higher photo-catalytic activity than that of the rutile-type. Therefore, the present invention has a feature of utilizing anatase-type titanium dioxide, in order to obtain strong oxidizing power and increase CO2 generation efficiency, by photo-catalytic activity. If the UV light with a wavelength of 340 to 380 nm is irradiated onto the TiO2 coated layer by the UV light mosquito-attracting lamp 210, a photochemical reaction occurs on the TiO2 coated layer which generates a hydroxyl radical (OH—) which has better oxidizing power and organic material-decomposing ability than ozone (O3). The organic compounds, such as by-products produced from mosquitoes killed by the fan 400 and dust and oil around the collecting container 100 are oxidized and decomposed into H2O and CO2 by the strong oxidizing power of hydroxyl radicals generated by the photochemical reaction. Disease-causing bacteria suspended in the air are also sterilized. This process can be expressed by the following chemical reaction:
Organic materials (carbon(C) compounds from offensive odor-producing bacteria and the like)+OH—→Inorganic materials (carbon(C)-removed compounds)+CO2+H2O

In this connection, it is apparent that mosquitoes are also attracted by CO2. The TiO2 coated layer does not change during the photochemical reaction, and the reaction continues to progress as long as the UV light is irradiated.

In addition, the photochemical reaction of the photo catalyst induced by UV light may remove offensive odors produced in livestock stables or daily life, and the carbon dioxide generated when the hydroxyl radical oxidizes organic compounds, functions as a lure attracting mosquitoes into the mosquito attracting and killing apparatus according to the present invention.

Although TiO2 is used as the photo catalyst herein, the present invention is not limited thereto. For example, ZrO2, ZnO, SnO2, CeO2, WO2, FeO3 or the like may be used. The photo catalyst-coated layer may also be formed on inner and outer surfaces of the collecting container 100, the body of the lamp, the reflective plate and the surface of the fan 400 to facilitate the photochemical reaction by the UV light which is emitted from the sun or lamps used in daily life.

Preferably, the collecting container 100 further comprises a carbon dioxide generating device for diffusing carbon dioxide at the inlet of the collecting container 100, to increase the number of mosquitoes attracted thereto.

As described previously, the mosquito attracting and killing apparatus with an air cleaning function according to the present invention comprises the UV light mosquito-attracting lamp, the fan, and the photo catalyst-coated layer, so that mosquitoes are attracted and killed simply by the operation of the fan, thereby solving the drawbacks contained in the conventional mosquito killing apparatuses using high voltage. The apparatus sterilizes mosquito-borne pathogens and air-borne pathogens by the photochemical reaction of the photo catalyst, and thus infection of humans and domestic animals with the pathogens can be prevented.

Further, in accordance with the present invention, use of a UV lamp emitting UV light with a wavelength of 340 nm to 380 nm, which is most suitable for attracting mosquitoes, generates carbon dioxide well by reaction with a photo catalyst-coated layer, and is less harmful to humans, and use of anatase type titanium dioxide can maximize effects of attracting and sterilizing mosquitoes.

In addition, the photochemical reaction of the photo catalyst caused by UV light can remove offensive odors produced in livestock stables or daily life. The carbon dioxide generated when hydroxyl radical oxidizes organic compounds serves as a lure attracting mosquitoes into the mosquito attracting and killing apparatus according to the present invention, thereby more effectively attracting and destroying mosquitoes compared to the conventional arts.

Further, separate installation of a tapered shape of a hopper within a collecting container provides easy cleaning, and improvement of mosquito sterilizing efficiency due to effective reflection of UV light and concentration of suction force of a fan.

While the present invention has been described in detail with reference to the preferred embodiment, those skilled in the art will appreciate that various modifications and substitutions can be made thereto without departing from the spirit and scope of the present invention as set forth in the appended claims.

1. A mosquito attracting and killing apparatus with an air cleaning function, comprising:
a collecting container having an inlet provided on an upper side thereof and an outlet provided on a lower side thereof, and a vacant space therein;
a hopper having a tapered shape, such that an inner diameter of an inlet provided on the upper side thereof is larger than that of an outlet provided on the lower side thereof;
a UV lamp, emitting UV light with a wavelength of 340 to 380 nm, and installed at the inlet of the collecting container such that a lamp body can be installed detachably therefrom;
a collecting net detachably installed at the outlet of the collecting container;
a TiO2 coated layer provided on the inner surface of the hopper by coating anatase type TiO2; and
a fan installed inside of the hopper so that mosquitoes, which have been attracted by CO2 produced by the UV light, and a photochemical reaction between the UV light and TiO2 coated layer, are killed in the course of being sucked into the collecting net by operation of the fan.

2. The mosquito attracting and killing apparatus of claim 1, further comprising:
a carbon dioxide generating device for diffusing carbon dioxide at the inlet of the collecting container.

3. The mosquito attracting and killing apparatus of claim 1, wherein a cable, connecting a switch installed on the outer surface of the collecting container and a motor for driving the fan and the lamp, is passed through a space between the collecting container and hopper.

4. The mosquito attracting and killing apparatus of claim 1, wherein anatase type TiO2 is further coated on the collecting container or a reflective plate provided on the lamp body in which the UV lamp is installed.
